(19) United States
(12) Patent Application Publication
(10) Pub. No.: US 2016/0078378 A1
(43) Pub. Date: Mar. 17, 2016

(54) Systems and Methods for Adjusting Existing Well Plans

(71) Applicant: Landmark Graphics Corporation, Houstan, TX (US)

(72) Inventors: Richard Daniel Colvin, Dripping Springs, TX (US); DeWayne Edward Pratt, Littleton, CO (US)

(73) Assignee: Landmark Graphics Corporation, Houston, TX (US)

(21) Appl. No.: 14/112,628

(22) PCT Filed: Apr. 22, 2013
(86) PCT No.: PCT/US13/37627

§ 371 Date: Oct. 18, 2013

(51) Int. Cl. G06Q 10/06; G06Q 50/06; G06F 17/30; E21B 41/00

(52) U.S. Cl. CPC G06Q 10/0637; E21B 41/0092; G06Q 50/06; G06F 17/30386

(57) ABSTRACT

Systems and methods for adjusting existing well plans by adjusting existing well plans by matching the existing well plans that can be replanned with new well plans that are generated around the existing well plans that cannot be replanned such as, for example, drilled, planned and/or permitted wells.

### CROSS-REFERENCE TO RELATED APPLICATIONS

This application and U.S. patent application Ser. No. 13/635,315, which is incorporated by reference, are commonly assigned to Landmark Graphics Corporation.

### STATEMENT REGARDING FEDERALLY SPONSORED RESEARCH

Not applicable.

### FIELD OF THE INVENTION

The present invention generally relates to systems and methods for adjusting existing well plans. More particularly, the present invention relates to adjusting existing well plans by matching the existing well plans that can be replanned with new well plans that are generated around on the existing well plans that cannot be replanned such as, for example, drilled, planned and/or permitted wells.

### BACKGROUND OF THE INVENTION

In today's oil and gas industry, wells that are deviated are most common and more often than not, deviated to horizontal—meaning an inclination of about 75-90 degrees. There are a number of established plays that utilize mass planning and targeting for horizontal drilling like the SAGD (Steam Assisted Gravity Drainage) in Canada and the Marcellus, Hornriver and Barnett shale gas plays. In order to optimize the number of wells to completely exploit one of these plays, companies are planning hundreds, and in some case thousands, of wells for an entire asset in a defined area, which is often very time-consuming and requires numerous resources. There are therefore, numerous types of resource plays that require horizontal laterals to be positioned and spaced to fill a field with a regular or irregular shaped lease or unit boundary. The objective is to maximize the coverage within this area based on lateral constraints, such as min/max lateral lengths, lateral spacing and heel/toe, heel/heel or toe/toe spacing. Companies often rely on conventional technology to help accomplish this objective and as a result are often limited with respect to the number of scenarios that can be analyzed. Once the drilling operation has commenced and information from wells being drilled is coming in from the field, engineers rely on conventional technology to update the field plan based on actual data and are limited in their options for re-distributing the remaining horizontal laterals. This process can easily take months to complete depending on the size of the field and the number of wells that are being planned.

One of the bigger issues with horizontal lateral field development involves modifying the field plan after some of the wells have been permitted and drilled. An operator might, for instance, have initially planned the field using 800 foot spacing between parallel horizontal wells and discovered that 750 foot spacing is more appropriate for this field due to the results of drilling and fracking the first few wells. Or, an operator might determine that the initially planned 330 degree well orientation is not as effective as a 320 degree orientation. At this point, several wells are drilled, a few more are currently being drilled and others may be permitted, but not drilled. Hundreds to thousands of wells may also be planned and identified within the operator's internal systems with unique identifiers. Those well plans need to be moved into new locations, without losing their reference to the operator's internal identification system. In addition to lateral movements, there may be a need to alter the vertical positioning. This might be required to adjust to a revised earth model or to target a different position within the reservoir, to give the wells more of an upward tilt, or to more closely follow the contours of the reservoir. Past attempts have involved convoluted workflows that require the operators to delete all non-permitted well plans, perform the planning, then try to determine which new plans might be close enough to the old ones to transfer the corporate identification over.

### BRIEF DESCRIPTION OF THE DRAWINGS

The present invention is described below with references to the accompanying drawings in which like elements are referenced with like reference numerals, and in which:

FIG. 1 is a flow diagram illustrating one embodiment of a method for implementing the present invention.

FIG. 2 is a flow diagram illustrating one embodiment of a method for performing step 103 in FIG. 1.

FIG. 3 is a flow diagram illustrating one embodiment of a method for performing step 105 in FIG. 1.

FIG. 4 is a flow diagram illustrating one embodiment of a method for performing step 316 in FIG. 3.

FIG. 5 is a plan view illustrating step 101 in FIG. 1.

FIG. 6 is a plan view illustrating step 102 in FIG. 1.

FIG. 7 is a plan view illustrating step 114 in FIG. 1.

FIG. 8 is a block diagram illustrating one embodiment of a computer system for implementing the present invention.

### DETAILED DESCRIPTION OF THE PREFERRED EMBODIMENTS

The subject matter of the present invention is described with specificity, however, the description itself is not intended to limit the scope of the invention. The subject matter thus, might also be embodied in other ways, to include different steps or combinations of steps similar to the ones described herein, in conjunction with other technologies. Moreover, although the term “step” may be used herein to describe different elements of methods employed, the term should not be interpreted as implying any particular order among or between various steps herein disclosed unless otherwise expressly limited by the description to a particular order. While the following description refers to the oil and gas industry, the systems and methods of the present invention are not limited thereto and may also be applied in other industries to achieve similar results.

The present invention overcomes one or more deficiencies in the prior art by adjusting existing well plans by matching the existing well plans that can be replanned with new well plans that are generated around the existing well plans that cannot be replanned such as, for example, drilled, planned and/or permitted wells.

In one embodiment, the present invention includes a method for adjusting existing well plans, which comprises: i) separating existing well plans that cannot be replanned into a ListA and existing well plans that can be replanned into a ListB; ii) generating new well plans around the ListA well plans; iii) separating the new well plans into a ListC; iv) determining which ListB well plans match respective ListC new well plans; v) adjusting each ListB well plan that matches a respective ListC new well plan to a new position; and vi) removing each ListC new well plan that matches a respective ListB well plan and each ListB well plan that does not match a respective ListC new well plan.

In another embodiment, the present invention includes a non-transitory program carrier device tangibly carrying computer executable instructions for adjusting existing well plans, the instructions being executable to implement: i) separating existing well plans that cannot be replanned into a ListA and existing well plans that can be replanned into a ListB; ii) generating new well plans around the ListA well plans; iii) separating the new well plans into a ListC; iv) determining which ListB well plans match respective ListC new well plans; v) adjusting each ListB well plan that matches a respective ListC new well plan to a new position; and vi) removing each ListC new well plan that matches a respective ListB well plan and each ListB well plan that does not match a respective ListC new well plan.

In yet another embodiment, the present invention includes a method for adjusting existing well plans, which comprises: i) separating existing well plans that cannot be replanned into a ListA and existing well plans that can be replanned into a ListB; ii) generating new well plans around the ListA well plans; iii) separating the new well plans into a ListC; iv) determining which ListB well plans match respective ListC new well plans by: a) determining initial matching criteria; b) identifying a list of possible matches for ListB well plans and ListC new well plans based on the initial matching criteria; and c) reducing the list of possible matches for ListB well plans and the list of possible matches for ListC new well plans to one best possible match for each respective well plan and its match; v) adjusting each ListB well plan that matches a respective ListC new well plan to a new position; and vi) removing each ListC new well plan that matches a respective ListB well plan and each ListB well plan that does not match a respective ListC new well plan.

### Method Description

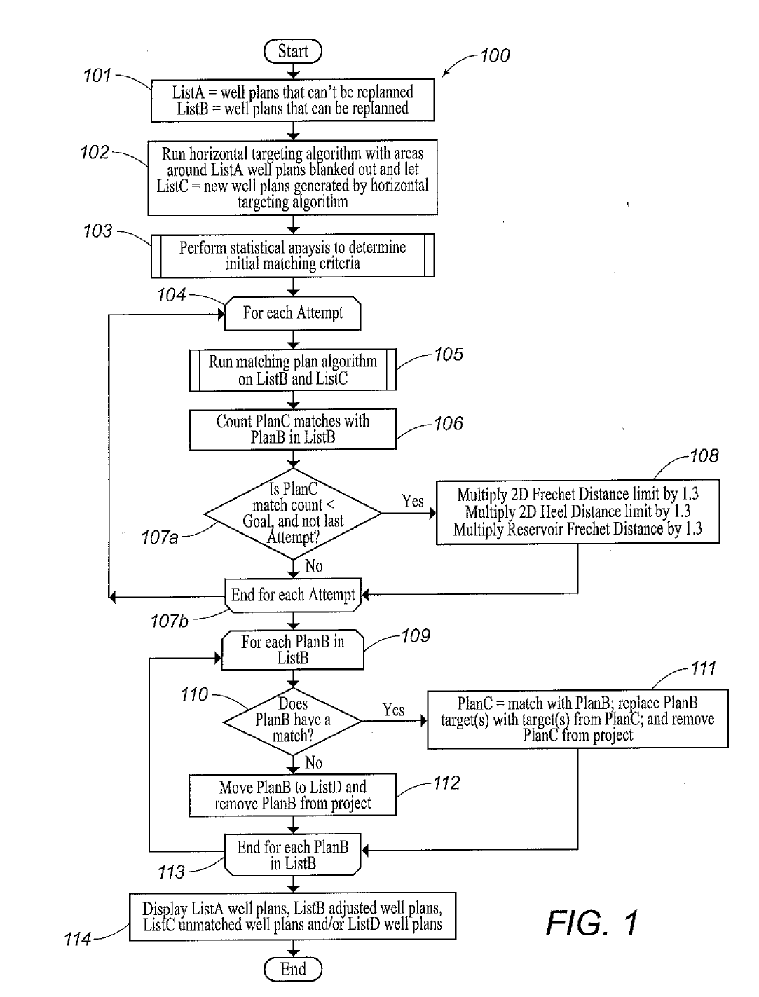

Referring now to FIG. 1, a flow diagram of one embodiment of a method 100 for implementing the present invention is illustrated.

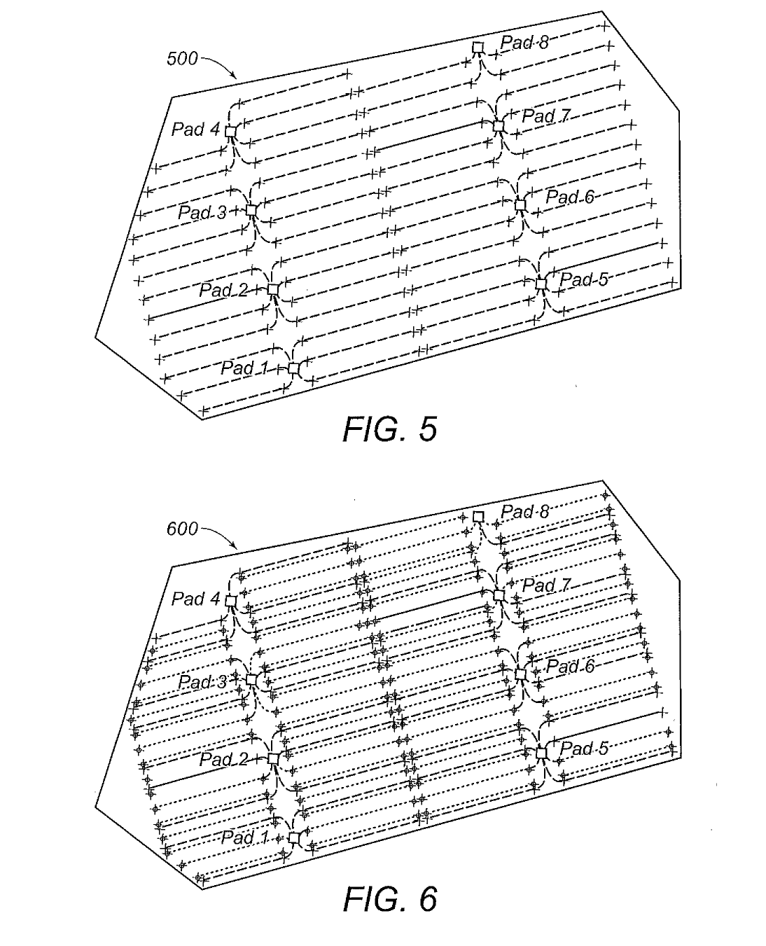

In step 101, ListA and ListB are set equal to well plans that cannot be replanned and well plans that can be replanned, respectively. ListA and ListB are plans within an existing field development project. In FIG. 5, for example, the plan view 500 illustrates an unconventional field with ListA existing well plans as solid lines and ListB existing well plans as dashed lines.

In step 102, a horizontal targeting algorithm is run with areas around ListA blanked out to generate new well plans that are set equal to ListC. The horizontal targeting algorithm utilizes current parameters and generates new well plans around the well plans in ListA that cannot be replanned. One example of a horizontal targeting algorithm that may be used for generating new lateral well plans around the well plans that cannot be replanned is described in U.S. patent application Ser. No. 13/635,315. In FIG. 6, the plan view 600 illustrates the same field in FIG. 5 with the addition of ListC new well plans as dotted lines. Because some of the ListB well plans are covered by the ListC well plans, they are not shown.

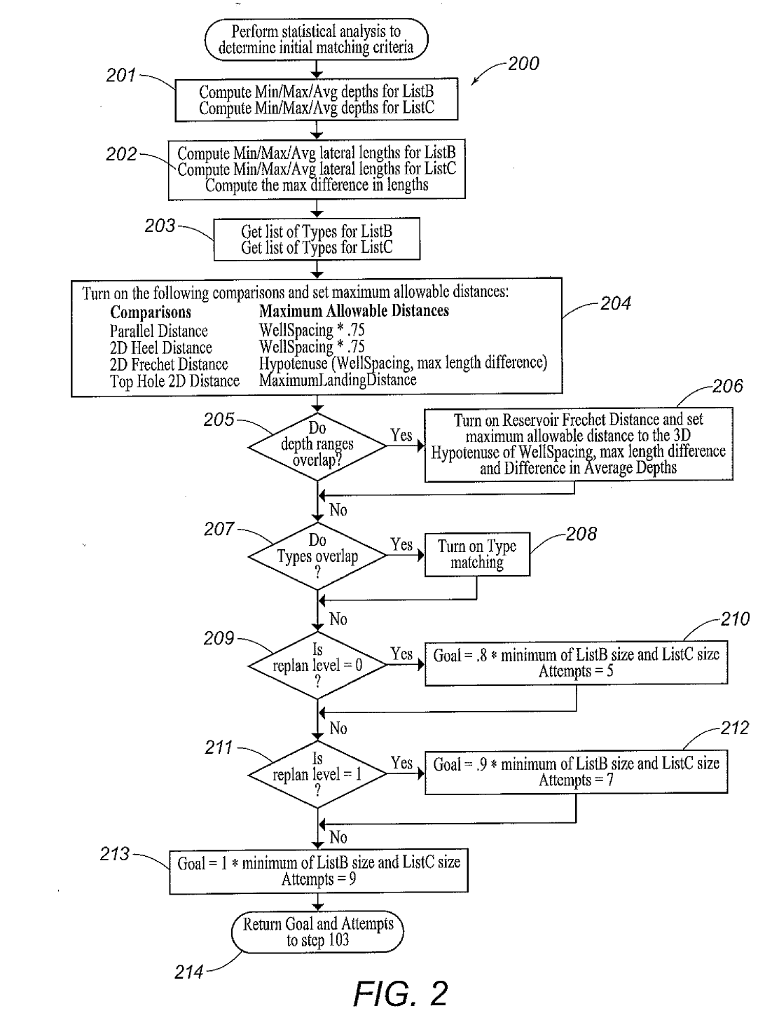

In step 103, a statistical analysis is performed to determine the initial matching criteria, which returns a Goal and number of Attempts used in steps 104 and 107a. One embodiment of a method for performing the statistical analysis is described further in reference to FIG. 2.

In step 104, the method 100 sets the maximum number of iterations for the loop defined by steps 104-107b to the number of Attempts from step 103.

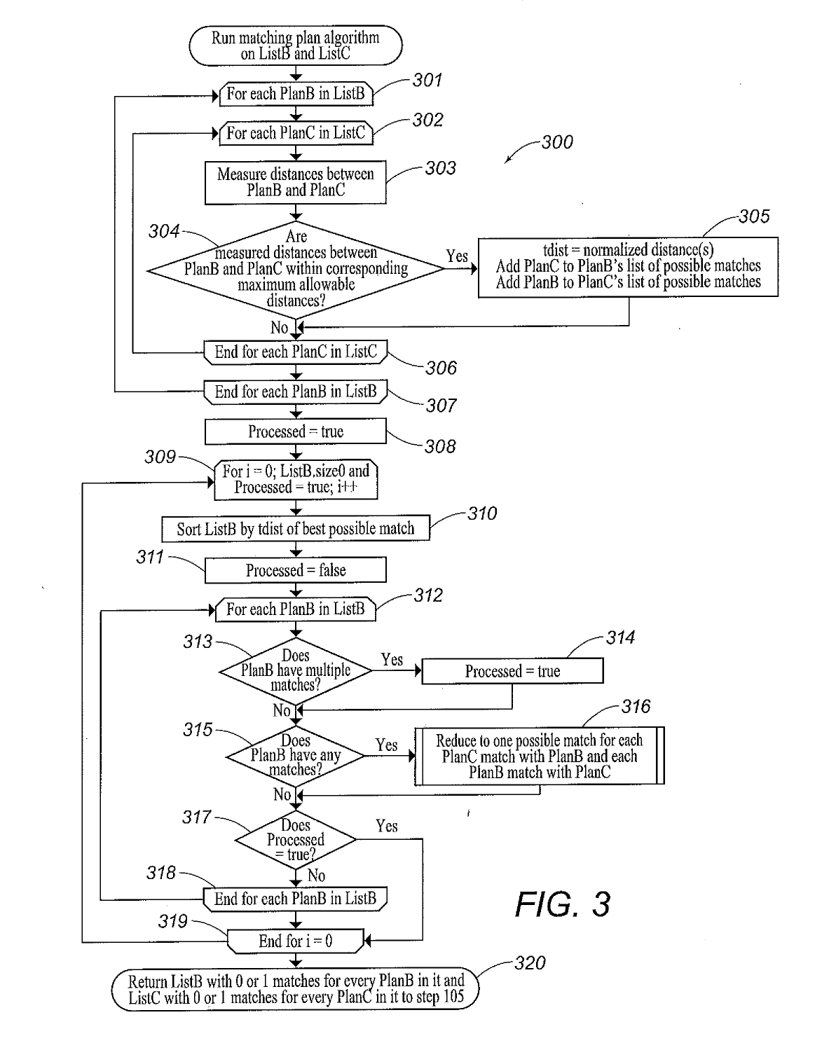

In step 105, a plan matching algorithm is run on ListB and ListC. One embodiment of a method for running the plan matching algorithm is described further in reference to FIG. 3.

In step 106, PlanC matches with PlanB in ListB from step 105 are counted. Because the maximum possible number of matches in either ListB or ListC is equal to the minimum size if the two lists, the matches may be counted from either list.

In step 107a, the method 100 determines if the PlanC match count from step 106 is less than the Goal from step 103 and if the Attempt identified in step 104 is not the last Attempt. If the PlanC match count is less than the Goal and it is not the last Attempt, then the method 100 proceeds to step 108. If the PlanC match count is not less than the Goal and it is the last Attempt, then the method 100 proceeds to step 107b.

In step 107b, the method 100 determines if the last Attempt from step 103 has been reached. If the last Attempt from step 103 has not been reached, then the method 100 returns to step 104 for another iteration of the loop. If the last Attempt from step 103 has been reached, then the method 100 proceeds to step 109.

In step 108, the 2D Frechet Distance limit from step 204 in FIG. 2, the 2D Heel distance limit from step 204 in FIG. 2 and the Reservoir Frechet Distance from step 206 in FIG. 2 are each multiplied 1.3 and returned to step 107b in order to try again with looser matching criteria.

In step 109, the method 100 identifies a separate PlanB and ListB from step 101 for each iteration through the loop defined by steps 109-113.

In step 110, the method 100 determines if PlanB has a match. If PlanB does not have a match, then the method 100 proceeds to step 112. If PlanB does have a match, then the method 100 proceeds to step 111.

In step 111, PlanC is set equal to the match with PlanB, the PlanB target(s) are replaced with the target(s) from PlanC and PlanC is removed from the project.

In step 112, PlanB is moved to a ListD and PlanB is removed from the project.

In step 113, the method 100 determines if the last PlanB in ListB from step 101 has been identified in step 109. If the last PlanB in ListB from step 101 has not been identified in step 109, then the method 100 returns to step 109 to identify another separate PlanB in ListB from step 101. If the last PlanB in ListB from step 101 has been identified in step 109, then the method 100 proceeds to step 114.

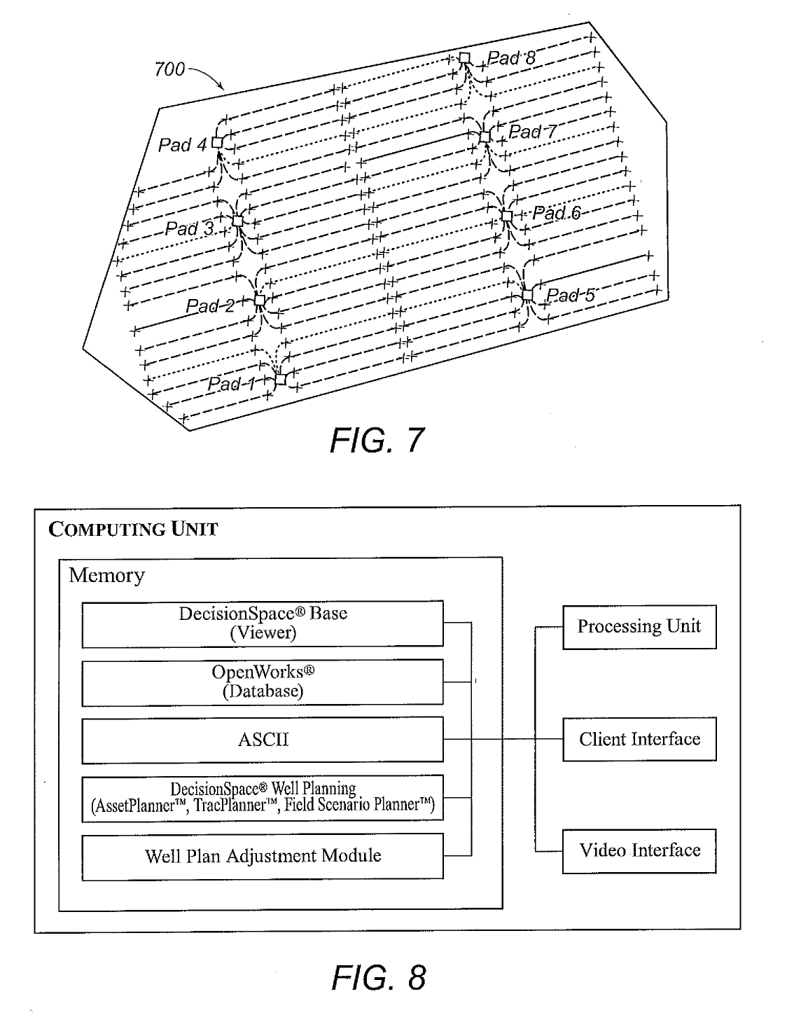

In step 114, ListA well plans, ListB adjusted well plans, ListC unmatched well plans and/or ListD well plans may be displayed using the client interface and/or the video interface described further in reference to FIG. 8. The ListD well plans may be displayed in a simple text list by unique name or other identification. In FIG. 7, the plan view 700 illustrates the same field in FIG. 6 wherein i) the remaining ListB well plans are adjusted to new positions and the matching new well plans in ListC have been removed; ii) the remaining ListC new well plans are unmatched with any well plans in ListB and the unmatched well plans in ListB have been removed; and iii) the ListA well plans remain the same. The removed ListB well plans may be moved to the ListD well plans for tracking and later identification.

Referring now to FIG. 2, a flow diagram of one embodiment of a method for performing step 103 in FIG. 1 is illustrated.

In step 201, minimum, maximum and average (“Min/Max/Avg”) depths are computed for ListB and ListC by measuring each plan in the respective lists.

In step 202, Min/Max/Avg lateral lengths are computed for ListB and ListC by measuring each plan in the respective lists. In addition, the maximum difference in the Min/Max/Avg lateral lengths for ListB and for ListC is computed and may be expressed as the maximum of (|ListCMin−ListBMin|, |ListCMax−ListBMax|, |ListCAvg−ListBAvg|).

In step 203, a list of Types for the plans in ListB and a list of Types for the plans in ListC are retrieved. If, for example, all the plans are the same type (e.g. “Producer”), then the list of Types will just have the string “Producer” identified therein. In a SAGD field, for example, there may be “Producer” and “Injector” plans such that both of those strings would be identified in the list of Types. In this event, it would make sense to match based on the Type of plan. On the other hand, if the original development was done using “Producer” Type plans and the new development was done with “Oil” Type plans, it would not make sense to match based on Type because there is no overlap.

In step 204, comparisons are turned on and maximum allowable distances are set. The comparisons are effectively tests using various well known distances that can be turned on or off and include, for example, Parallel Distance, 2D Heel Distance, 2D Frechet Distance and Top Hole 2D Distance. Parallel Distance is the distance obtained by drawing a line perpendicular to one plan and its heel and another line through the other plan running through the heel and bottom hole locations, and measuring the distance from that intersection to the heel of the first plan. 2D Heel Distance is the x,y distance between heel positions for two plans. 2D Frechet Distance is similar to the well known Frechet Distance, but is only measured in lateral dimensions without any depth. Reservoir Frechet distance is the Frechet distance measured in 3D, but only over the portion of the plan that is down in the reservoir (heel to toe),

The comparisons are turned off by default. For each comparison that gets turned on (except for Type matching), there is a maximum allowable distance that is set and allowed such as, for example, well spacing (“WellSpacing”), Hypotenuse and maximum landing distance (“MaximumLandingDistance”). WellSpacing and MaximumDistanceLanding are predetermined input distances. Hypotenuse is computed using the Pythagorean formula wherein the two known sides are the max length difference and WellSpacing. The max length distance is the maximum difference in lengths computed in step 202. The maximum allowable distances for the 2D Frechet Distance and the 2D Heel Distance may be incremented in step 108.

In step 205, the method 200 determines whether depth ranges overlap. In other words, the method 200 determines whether the Min/Max depth for the plans in ListB overlap with the Min/Max depths for the plans in ListC. If the depth ranges do not overlap, then the method 200 proceeds to step 207. If the depth ranges do overlap, then the method 200 proceeds to step 206.

In step 206, the Reservoir Frechet Distance is turned on for comparison and its maximum allowable distance is set to the 3D Hypotenuse of WellSpacing, max length difference and Difference in Average Depths. The Difference in Average Depths is determined by the results of step 201 and the max length difference is the max difference in lengths computed in step 202. The maximum allowable distance for the Reservoir Frechet Distance may be incremented in step 108.

In step 207, the method 200 determines whether Types overlap from the list of Types for ListB and the list of Types for ListC from step 203. If the Types do not overlap, then the method 200 proceeds to step 209. If the Types do overlap, then the method 200 proceeds to step 208.

In step 208, Type matching is turned on for comparison.

In step 209, the method 200 determines if a replan level equals 0. The replan level is a predetermined parameter where 0 indicates a higher match quality, 2 indicates a lower match quality and 1 indicates a match quality between the higher match quality (0) and the lower match quality (2). If the replan level does not equal 0, then the method 200 proceeds to step 211. If the replan level does equal 0, then the method 200 proceeds to step 210.

In step 210, the Goal used in step 107a is set equal to 0.8* minimum of ListB size and ListC size, and the Attempts used in step 104 is set equal to 5.

In step 211, the method 200 determines the replan level is equal to 1. If the replan level does not equal 1, then the method 200 proceeds to step 213. If the replan level does equal 1, then the method 200 proceeds to step 212.

In step 212, the Goal used in step 107a is set to equal 0.9* minimum of ListB size and ListC size, and the Attempts used in step 104 is set equal to 7.

In step 213, the Goal used in step 107a is set to equal 1* minimum of ListB size and ListC size, and the Attempts used in step 104 is set equal to 9.

In step 214, the Goal and Attempts are returned to step 103 in FIG. 1.

Referring now to FIG. 3, a flow diagram of one embodiment of the method 300 for performing step 105 in FIG. 1 is illustrated. The method 300 utilizes ListB and ListC wherein each plan in each list has the capability of maintaining a list of possible matches for that plan (in sorted order). The method 300 also utilizes a list of distance measurements that can be turned on and that each have maximum values listed that cannot be exceeded if two plans are not to be considered possible matches. The on/off state and maximum allowable distances are established in the method 200 of FIG. 2 and are incremented by the method 100 in FIG. 1.

In step 301, the method 300 identifies a separate PlanB in ListB for each iteration through the loop defined by steps 301-307.

In step 302, the method 300 identifies a separate PlanC in ListC for each iteration through the loop defined by steps 302-306.

In step 303, distances between PlanB and PlanC are measured according to the comparisons turned on in steps 204, 206 and the Type matching turned on in step 208. If, for example, 2D Heel Distance and 2D Frechet Distance are turned on in step 204, then these are the distances measured between PlanB and PlanC in step 303.

In step 304, the method 300 determines if the distances measured in step 303 are within the corresponding maximum allowable distances set in steps 204, 206. If the measured distances between PlanB and PlanC are not within the corresponding maximum allowable distances, then the method 300 proceeds to step 306. If the measured distances between PlanB and PlanC are within the corresponding maximum allowable distances, then the method 300 proceeds to step 305.

In step 305, tdist is set equal to normalized distance(s). In this manner, tdist represents the square root of the sum of the squared normalized distance(s) wherein the normalized distance(s) represent(s) the measured distances from step 303 that are normalized and expressed as a percent of the corresponding maximum allowable distance(s) from step 204 and possibly steps 206, 208. Each list of possible matches is sorted according to ascending values for tdist. In addition, PlanC is added to PlanB's list of possible matches and PlanB is added to PlanC's list of possible matches.

In step 306, the method 300 determines if the last PlanC in ListC has been identified in step 302. If the last PlanC in ListC has not been identified in step 302, then the method 300 returns to step 302 to identify another separate PlanC in ListC. If the last PlanC in ListC has been identified in step 302, then the method 300 proceeds to step 307.

In step 307, the method 300 determines if the last PlanB in ListB has been identified in step 301. If the last PlanB in ListB has not been identified in step 301, then the method 300 returns to step 301 to identify another separate PlanB in ListB. If the last PlanB in ListB has been identified in step 301, then the method 300 proceeds to step 308.

In step 308, a Boolean variable called Processed is initialized to true to insure that the loop beginning with step 309 is run at least once, assuming that ListB is not empty. Processed will be used in steps 314 and 317 to insure that the processing in the loop beginning with step 312 stops after a PlanB with multiple matches has been processed and again in step 318 to cause the loop defined by steps 309-319 to terminate once an entire run through ListB is completed without any multiple match plans being processed.

In step 309, the method 300 identifies the size of ListB by the number of plans therein and sets a value for Processed that equals true for the loop defined by steps 309-319.

In step 310, ListB is sorted by the tdist value of the best possible match for each PlanB in ListB. In this manner, the best overall combination of matches can be achieved.

In step 311, Processed is set equal to false.

In step 312, the method 300 identifies a separate PlanB in ListB for each iteration through the loop defined by steps 312-318.

In step 313, the method 300 determines if PlanB has multiple matches. If PlanB does not have multiple matches, then the method 300 proceeds to step 315. If PlanB has multiple matches, then the method 300 proceeds to step 314.

In step 314, Processed is set equal to true.

In step 315, the method 300 determines if PlanB has any matches. If PlanB does not have any matches, then the method 300 proceeds to step 317. If PlanB has any matches, then the method 300 proceeds to step 316.

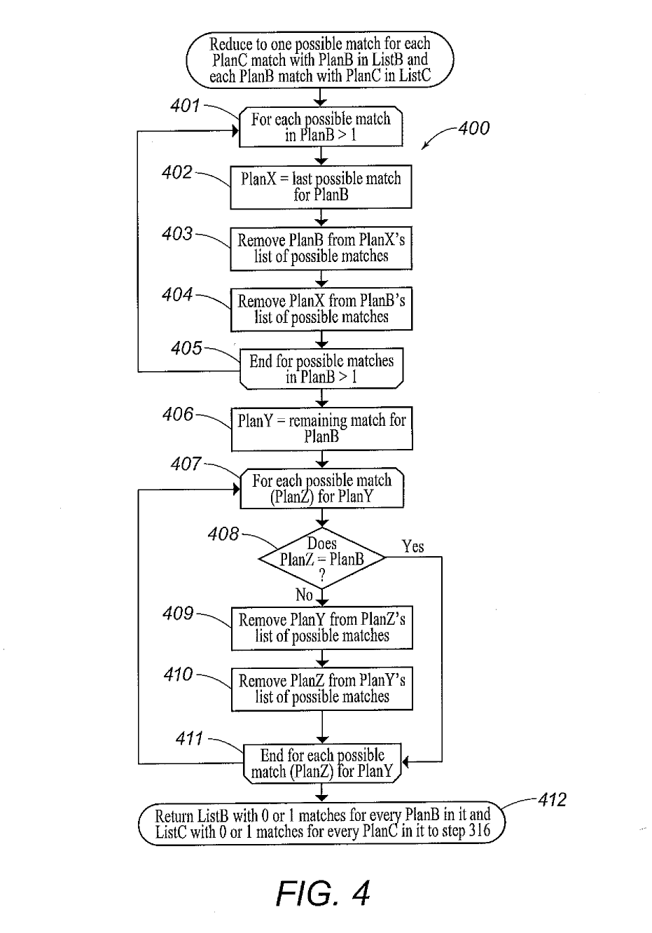

In step 316, the PlanB list of possible matches is reduced to one possible match for it and the PlanC list of possible matches is reduced to one possible match for it. Because this step potentially impacts both PlanB and PlanC it is necessary even if the PlanB list of possible matches only includes PlanC. One embodiment of a method for performing this step is described further in reference to FIG. 4.

In step 317, the method 300 determines if Processed equals true. If Processed equals true, then the method 300 proceeds to step 319. If Processed does not equal true, then the method 300 proceeds to step 318.

In step 318, the method 300 determines if the last PlanB in ListB has been identified in step 312. If the last PlanB in ListB has not been identified in step 312, then the method 300 returns to step 312 to identify another separate PlanB in ListB. If the last PlanB in ListB has been identified in step 312, then the method 300 proceeds to step 319.

In step 319, the method 300 determines if the size of ListB has been reached or if Processed equals false. If the size of ListB has not been reached or if Processed equals true, then the method 300 returns to step 309 for another iteration of the loop. If the size of ListB has been reached or if Processed equals false, then the method 300 proceeds to step 320.

In step 320, ListB is returned with 0 or 1 matches for every PlanB in it and ListC is returned with 0 or 1 matches for every PlanC in it to step 105 in FIG. 1.

Referring now to FIG. 4, a flow diagram of one embodiment of a method 400 for performing step 316 in FIG. 3. is illustrated.

In step 401, the method 400 identifies a separate possible match in PlanB that is greater than 1 for each iteration through the loop defined by steps 401-405.

In step 402, PlanX is set equal to the last possible match for PlanB. Because the possible matches are sorted by ascending tdist, the last possible match in the list will be the worst match, meaning farthest apart, which is set equal to PlanX.

In step 403, PlanB is removed for PlanX's list of possible matches.

In step 404, PlanX is removed from PlanB's list of possible matches.

In step 405, the method 400 determines if the last possible match in PlanB greater than 1 has been identified in step 401. If the last possible match in PlanB greater than 1 has not been identified in step 401, then the method 400 returns to step 401 to identify another separate possible match in PlanB that is greater than 1. If the last possible match in PlanB greater than 1 has been identified in step 401, then the method 400 proceeds to step 406.

In step 406, PlanY is set equal to the remaining match for PlanB.

In step 407, the method 400 identifies a separate possible match (PlanZ) for PlanY for each iteration through the loop defined by steps 407-411.

In step 408, the method 400 determines if PlanZ equals PlanB. If PlanZ equals PlanB, then the method 400 proceeds to step 411. If PlanZ does not equal PlanB, then the method 400 proceeds to step 409.

In step 409, PlanY is removed from PlanZ's list of possible matches.

In step 410, PlanZ is removed from PlanY's list of possible of matches.

In step 411, the method 400 determines if the last possible match (PlanZ) for PlanY has been identified in step 407. If the last possible match (PlanZ) for PlanY has not been identified in step 407, then the method 400 returns to step 407 to identify another separate possible match (PlanZ) for PlanY. If the last possible match (PlanZ) for PlanY has been identified in step 407, then the method 400 proceeds to step 412.

In step 412, ListB is returned with 0 or 1 matches for every PlanB in it and ListC is returned with 0 or 1 matches for every PlanC in it to step 316 in FIG. 3.

### System Description

The present invention may be implemented through a computer-executable program of instructions, such as program modules, generally referred to as software applications or application programs executed by a computer. The software may include, for example, routines, programs, objects, components and data structures that perform particular tasks or implement particular abstract data types. The software forms an interface to allow a computer to react according to a source of input. DecisionSpace® Well Planning, which is a commercial software application marketed by Landmark Graphics Corporation, may be used as an interface application to implement the present invention. The software may also cooperate with other code segments to initiate a variety of tasks in response to data received in conjunction with the source of the received data. The software may be stored and/or carried on any variety of memory such as CD-ROM, magnetic disk, bubble memory and semiconductor memory (e.g., various types of RAM or ROM). Furthermore, the software and its results may be transmitted over a variety of carrier media such as optical fiber, metallic wire and/or through any of a variety of networks, such as the Internet.

Moreover, those skilled in the art will appreciate that the invention may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present invention. The invention may be practiced in distributed-computing environments where tasks are performed by remote-processing devices that are linked through a communications network. In a distributed-computing environment, program modules may be located in both local and remote computer-storage media including memory storage devices. The present invention may therefore, be implemented in connection with various hardware, software or a combination thereof, in a computer system or other processing system.

Referring now to FIG. 8, a block diagram illustrates one embodiment of a system for implementing the present invention on a computer. The system includes a computing unit, sometimes referred to as a computing system, which contains memory, application programs, a database, a viewer, ASCII files, a client interface, a video interface, and a processing unit. The computing unit is only one example of a suitable computing environment and is not intended to suggest any limitation as to the scope of use or functionality of the invention.

The memory primarily stores the application programs, which may also be described as application modules containing computer-executable instructions, executed by the computing unit for implementing the present invention described herein and illustrated in FIGS. 1-7. The memory therefore, includes OpenWorks®, which may be used as a database to supply data and/or store data results such as, for example, subsurface grids, surface elevations and the lists from step 101 in FIG. 1. ASCII files may also be used to supply data and/or store the data results. The memory also includes DecisionSpace® Base, which may be used as a viewer to display the data and data results such as, for example, map images, surface and subsurface grids loaded from OpenWorks® into DecisionSpace® Base that are used to define the lease or acreage boundaries.

The horizontal targeting mode in AssetPlanner™ uses predefined lease, acreage or grid boundaries to determine the positioning requirements for the horizontal laterals—also referred to as targets, target pairs, or stubs. Subsurface 3D grids loaded into OpenWorks® may also be used within DecisionSpace® Well Planning as boundaries. These boundaries are used to generate a pattern of target pairs that fill the area based on parameters entered in the horizontal targeting and planning modes of AssetPlanner™ and Field Scenario Planner™.

In one application, for example, the pattern of target pairs may initially be generated given a direction parameter of about 300° and spacing of about 800 feet within the defined area of the boundaries using the client interface. The generated horizontal lateral stubs (or target pairs) created from the initial processing can be recalled at a later time, via the database or ASCII file, where upon the replan functionality is run with new parameters to redefine the stubs. By retaining the well naming from the original horizontal targeting, manual effort is considerably reduced, and the original wells can continue to be processed in other systems or agencies. The horizontal targeting mode of the AssetPlanner™ application in DecisionSpace® Well Planning thus, processes the foregoing data using the methods described in reference to step 102 illustrated in FIG. 1 to generate the desired horizontal targeting pattern(s). The well plan adjustment module may be used to interface with the applications in DecisionSpace® Well Planning to perform the remaining steps in FIG. 1 (103-113), the results of which in step 114 may be displayed by DecisionSpace® Base using the client interface and/or the video interface. Although DecicisionSpace® Base, OpenWorks® and DecisionSpace® Well Planning may be used as interface applications, other interface applications may be used, instead, or the well plan adjustment module may be used as a stand-alone application. DecisionSpace® Base, TracPlanner™, Field Scenario Planner™, AssetPlanner™ and OpenWorks® are commercial software applications marketed by Landmark Graphics Corporation.

Although the computing unit is shown as having a generalized memory, the computing unit typically includes a variety of computer readable media. By way of example, and not limitation, computer readable media may comprise computer storage media and communication media. The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to, and/or presently being operated on, the processing unit. By way of example, and not limitation, the computing unit includes an operating system, application programs, other program modules, and program data.

The components shown in the memory may also be included in other removable/nonremovable, volatile/nonvolatile computer storage media or they may be implemented in the computing unit through an application program interface (“API”) or cloud computing, which may reside on a separate computing unit connected through a computer system or network. For example only, a hard disk drive may read from or write to nonremovable, nonvolatile magnetic media, a magnetic disk drive may read from or write to a removable, nonvolatile magnetic disk, and an optical disk drive may read from or write to a removable, nonvolatile optical disk such as a CD ROM or other optical media. Other removable/non-removable, volatile/nonvolatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above provide storage of computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like. These and other input devices are often connected to the processing unit through the client interface that is coupled to a system bus, but may be connected by other interface and bus structures, such as a parallel port or a universal serial bus (USB).

A monitor or other type of display device may be connected to the system bus via an interface, such as a video interface. A graphical user interface (“GUI”) may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well known.

While the present invention has been described in connection with presently preferred embodiments, it will be understood by those skilled in the art that it is not intended to limit the invention to those embodiments. It is therefore, contemplated that various alternative embodiments and modifications may be made to the disclosed embodiments without departing from the spirit and scope of the invention defined by the appended claims and equivalents thereof.

1. A method for adjusting existing well plans, which comprises:
separating existing well plans that cannot be replanned into a ListA and existing well plans that can be replanned into a ListB;
generating new well plans around the ListA well plans;
separating the new well plans into a ListC;
determining which ListB well plans match respective ListC new well plans;
adjusting each ListB well plan that matches a respective ListC new well plan to a new position; and
removing each ListC new well plan that matches a respective ListB well plan and each ListB well plan that does not match a respective ListC new well plan.

2. The method of claim 1, wherein the ListA well plans comprise at least one of drilled, planned and permitted wells.

3. The method of claim 1, wherein each ListB well plan that is removed is moved to a ListD for tracking and identification.

4. The method of claim 1, wherein determining which ListB well plans match respective ListC new well plans comprises:
determining initial matching criteria;
identifying a list of possible matches for ListB well plans and ListC new well plans based on the initial matching criteria; and
reducing the list of possible matches for ListB well plans and the list of possible matches for ListC new well plans to one best possible match for each respective well plan and its match.

5. The method of claim 4, wherein the initial matching criteria comprise multiple goals based on a minimum number of well plans in ListB and a minimum number of new well plans in ListC.

6. The method of claim 1, wherein adjusting each ListB well plan that matches a respective ListC new well plan to a new position comprises replacing each target for each ListB well plan that matches a respective ListC new well plan with each target from each respective ListC new well plan.

7. The method of claim 4, wherein identifying the list of possible matches for ListB well plans and ListC well plans comprises a comparison of measured distances between ListB well plans and ListC new well plans and corresponding maximum allowable distances.

8. The method of claim 7, wherein reducing the list of possible matches for ListB well plans and the list of possible matches for ListC new well plans to the one best possible match for each respective well plan and its match comprises iteratively eliminating a worst possible match based on a normalization of the measured distances between ListB well plans and ListC new well plans.

9. A non-transitory program carrier device tangibly carrying computer executable instructions for adjusting existing well plans, the instructions being executable to implement:
separating existing well plans that cannot be replanned into a ListA and existing well plans that can be replanned into a ListB;
generating new well plans around the ListA well plans;
separating the new well plans into a ListC;
determining which ListB well plans match respective ListC new well plans;
adjusting each ListB well plan that matches a respective ListC new well plan to a new position; and
removing each ListC new well plan that matches respective a ListB well plan and each ListB well plan that does not match a respective ListC new well plan.

10. The program carrier device of claim 9, wherein the ListA well plans comprise at least one of drilled, planned and permitted wells.

11. The program carrier device of claim 9, wherein each ListB well plan that is removed is moved to a ListD for tracking and identification.

12. The program carrier device of claim 9, wherein determining which ListB well plans match respective ListC new well plans comprises:
determining initial matching criteria;
identifying a list of possible matches for ListB well plans and ListC new well plans based on the initial matching criteria; and
reducing the list of possible matches for ListB well plans and the list of possible matches for ListC new well plans to one best possible match for each respective well plan and its match.

13. The program carrier device of claim 12, wherein the initial matching criteria comprise multiple goal based on a minimum number of well plans in ListB and a minimum number of new well plans in ListC.

14. The program carrier device of claim 9, wherein adjusting each ListB well plan that matches a respective ListC new well plan to a new position comprises replacing each target for each ListB well plan that matches a respective ListC new well plan with each target from each respective ListC new well plan.

15. The program carrier device of claim 12, wherein identifying the list of possible matches for. ListB well plans and ListC well plans comprises a comparison of measured distances between ListB well plans and ListC new well plans and corresponding maximum allowable distances.

16. The program carrier device of claim 15, wherein reducing the list of possible matches for ListB well plans and the list of possible matches for ListC new well plans to the one best possible match for each respective well plan and its match comprises iteratively eliminating a worst possible match based on a normalization of the measured distances between ListB well plans and ListC new well plans.

17. A method for adjusting existing well plans, which comprises:
separating existing well plans that cannot be replanned into a ListA and existing well plans that can be replanned into a ListB;
generating new well plans around the ListA well plans;
separating the new well plans into a ListC;
determining which ListB well plans match respective ListC new well plans by:
determining initial matching criteria;
identifying a list of possible matches for ListB well plans and ListC new well plans based on the initial matching criteria; and
reducing the list of possible matches for ListB well plans and the list of possible matches for ListC new well plans to one best possible match for each respective well plan and its match;
adjusting each ListB well plan that matches a respective ListC new well plan to a new position; and
removing each ListC new well plan that matches a respective ListB well plan and each ListB well plan that does not match a respective ListC new well plan.

18. The method of claim 17, wherein the initial matching criteria comprise multiple goals based on a minimum number of well plans in ListB and a minimum number of new well plans in ListC.

19. The method of claim 17, wherein adjusting each ListB well plan that matches a respective ListC new well plan to a new position comprises replacing each target for each ListB well plan that matches a respective ListC new well plan with each target from each respective ListC new well plan.

20. The method of claim 17, wherein identifying the list of possible matches for ListB well plans and ListC well plans comprises a comparison of measured distances between ListB well plans and ListC new well plans and corresponding maximum allowable distances.
